(19) United States
(12) Patent Application Publication
(10) Pub. No.: US 2022/0075366 A1
(43) Pub. Date: Mar. 10, 2022

(54) METHOD AND DEVICE FOR THE TELEOPERATED DRIVING OF A VEHICLE

(71) Applicant: Robert Bosch GmbH, Stockholm (DE)

(72) Inventors: Frederik Blank, Ludwigsburg (DE); Karl Theo Floess, Heilbronn (DE); Alexander Geraldy, Hildesheim (DE); Behzad Benam, Leonberg (DE); Erik Walossek, Giesen (DE); Jan Wolter, Hannover (DE); Jens Schwardmann, Hildesheim (DE); Kurt Eckert, Ditzingen (DE)

(21) Appl. No.: 17/422,961

(22) PCT Filed: Mar. 2, 2020
(86) PCT No.: PCT/EP2020/055400

§ 371 Date: Jul. 14, 2021

(30) Foreign Application Priority Data
Apr. 5, 2019 (DE) 10 2019 204 943.5

(51) Int. Cl. G05D 1/00; H04W 4/44; B60W 60/00

(52) U.S. Cl. CPC G05D 1/0022; H04W 4/44; G05D 2201/0213; B60W 60/001; G05D 1/0038

(57) ABSTRACT

A method for the teleoperated driving of a vehicle. In the method, a prediction is made with respect to a future quality of service of a mobile communications link of the vehicle to a vehicle control center. Pieces of knowledge are acquired relating to surroundings of the vehicle. Adaptations relating to the teleoperated driving are carried out based on the pieces of knowledge and on the prediction.

### FIELD

The present invention relates to a method for the teleoperated driving of a vehicle. The present invention also relates to a corresponding device, to a corresponding computer program and to a corresponding memory medium.

### BACKGROUND INFORMATION

Semi-autonomous vehicles according to the related art require a vehicle driving interface (“driver workstation”) as well as a person fit to drive and authorized to drive the vehicle as the vehicle occupant, who is able to take over the driving when needed. The object of numerous research projects involves so-called teleoperated driving (ToD), in which the vehicle may be assisted by means of a remote control when managing challenging scenarios—such as detours via dirt roads, alternative and unconventional routes or the like—or the driving task may be temporarily or fully taken over by an external operator in a control center, the so-called teleoperator. Vehicle and control center or its operator are interconnected for this purpose by a mobile communications network usually having a low latency and a high data rate.

U.S. Pat. No. 9,494,935 B2 describes computer devices, systems and methods for the remote control of an autonomous passenger vehicle. If an autonomous vehicle encounters unexpected surroundings such as, for example, a road construction site or an obstacle, which is unsuited for autonomous operation, the vehicle sensors are able to detect data about the vehicle and the unexpected surroundings, including image data, radar data and LIDAR data, etc. The detected data may be sent to a remote operator. The remote operator may operate the vehicle manually or issue instructions to the autonomous vehicle, which are to be carried out by various vehicle systems. The detected data sent to the remote operator may be optimized in order to save bandwidth, for example, by sending a limited subset of the detected data.

A vehicle described in U.S. Pat. No. 9,767,369 B2 may receive one or multiple image(s) of surroundings of the vehicle. The vehicle may also receive a surroundings map. The vehicle may also compare at least one feature in the images to one or multiple feature(s) in the map. The vehicle may also identify a certain area in the one or the multiple image(s), which corresponds to a portion of the map situated at a threshold distance from the one or the multiple feature(s). The vehicle may also compress the one or the multiple image(s) in order to record a smaller number of details in areas of the images than in the given area. The vehicle may also provide the compressed images to a remote system and, in response thereto, receive operating instructions from the remote system.

Systems and methods described in U.S. Pat. No. 9,465,388 B1 enable an autonomous vehicle to request assistance from a remote operator when the confidence of the vehicle in the operation is low. One exemplary method encompasses the operation of an autonomous vehicle in a first autonomous mode. The method may also encompass the identification of a situation in which a confidence level of an autonomous operation in the first autonomous mode is below a threshold level. The method may furthermore encompass the transmission of a request for assistance to a remote assistant, the request including sensor data representative of a portion of surroundings of the autonomous vehicle. The method may additionally encompass the reception of a response from the remote assistant, the response indicating a second autonomous operating mode. The method may also cause the autonomous vehicle to operate in the second autonomous operating mode according to the response from the remote assistant.

U.S. Pat. No. 9,720,410 B2 describes a further method for remotely assisting autonomous vehicles in predetermined situations.

### SUMMARY

The present invention provides a method for the teleoperated driving of a vehicle, a corresponding device, a corresponding computer program as well as a corresponding memory.

An advantage of the approach in accordance with an example embodiment of the present invention is in the high functional safety so that essential safety objectives of the vehicle are achieved: The vehicle is able to be transferred to a safe state at any point in time, and the vehicle poses no risk to the surroundings.

Advantageous refinements of and improvements on the basic features of the present invention are disclosed herein. Thus, for example, adaptations of the ToD functionality may be provided based on the predicted quality of service (QoS) in conjunction with the measurements of the vehicle's surroundings carried out by the vehicle itself. This enables an advantageous combination of QoS prediction, pieces of sensor information and functionally safe adaptation of the ToD functionality and of its functional parameters.

According to one further aspect of the present invention, it may be provided to identify and to appropriately take into account during the adaptations a hazard zone situated ahead of the vehicle based on pieces of knowledge relating to the vehicle surroundings. This approach also permits a limitation or enabling of the ToD function and its functional parameters corresponding to the predicted QoS and to the minimum required transfer rate for achieving a safe state, even in the case of pending danger.

According to one further aspect of the present invention, it may be provided to ascertain and to adapt both in advance and continuously the limitation, enablement or other adaptation of the permitted ToD functionality. Such a limitation, taking a preceding hazard analysis into account, may be a map including pieces of information about the surroundings conditions or pieces of information obtained from other vehicles.

### BRIEF DESCRIPTION OF THE DRAWINGS

Exemplary embodiments of the present invention are represented in the figures and explained in greater detail below.

FIG. 1 shows the sequence of a ToD adaptation based on the predicted QoS.

FIG. 2 schematically shows a QoS prediction according to the present invention.

FIG. 3 shows the dependency of safe states on the driving situation and surroundings.

### DETAILED DESCRIPTION OF EXAMPLE EMBODIMENTS

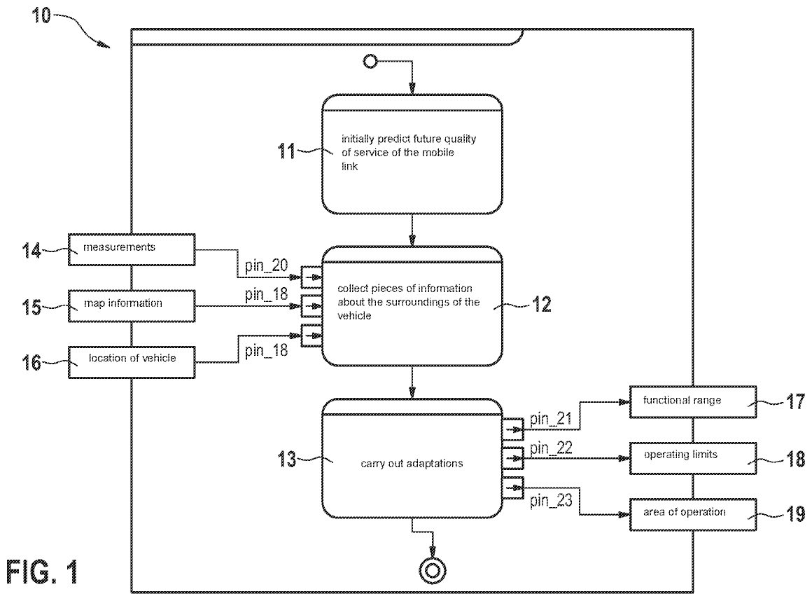

FIG. 1 illustrates a method 10 according to an example embodiment of the present invention for the teleoperated driving of a vehicle based on an activity diagram according to UML 2: The future quality of service of the mobile communications link of the vehicle to its vehicle control center is initially predicted (action 11). Pieces of information about the surroundings of the vehicle are then collected (action 12). Finally, based on pieces of knowledge 14, 15, 16 obtained in this manner and on the prediction, a wide variety of adaptations are carried out (action 13), which are to be explained below.

Thus, for example, the permitted parameterized limiting values 18 of the ToD function, selection 17 of possible ToD functions itself or drivable region 19 may, for example, be adapted depending on the surroundings, the condition of the vehicle, the event and the QoS prediction. In this way, the quality of the image transferred to the operator may, for example, be limited according to the transfer rate or to other QoS criteria of the radio link, or the type of control or other operating modes may be adapted. This concerns, for example, the direct control of the longitudinal and lateral control as a specification of a path (maneuvering) instead of the specification of a trajectory, which exclusively the vehicle itself may negotiate autonomously.

Action 13, which makes decisions about possible functional range 17, operating limits 18 or area of operation 19, may be based both on a previously established lookup table as well as on an evaluation logic, which continuously takes the maximum allowable safety risk into account. A combination of both mechanisms for increasing the reliability of the corresponding component is also possible.

Examples of parameterized operating limits (limits, 18) include minimum and maximum driving velocity, maximum steering torque as well as minimum safety distance to individual objects or to objects determined collectively based on their class.

A ToD operator typically controls the vehicle from a vehicle control center (VCC) without direct visual contact solely on the bases of pieces of vehicle and surroundings information, which are obtained primarily by measurements 14 of the vehicle. Functional range 17 of this control may be selectively adapted as a function of the prediction made in action 11 and of pieces of knowledge 14, 15, 16 acquired in action 12:
1. The operator directly or indirectly controls the actuators of the vehicle via the mobile communications link.
2. The operator specifies via the mobile communications link a trajectory or movement path, which the vehicle itself must negotiate autonomously.
3. The operator inputs via the mobile communications link a target toward which the vehicle itself is to move autonomously while calculating a suitable trajectory.

Area of operation 19 may be established either by marking corridors on the map, in which the vehicle is allowed to move or, conversely, restricted zones not unblocked for negotiation are defined, which the vehicle is not allowed to negotiate.

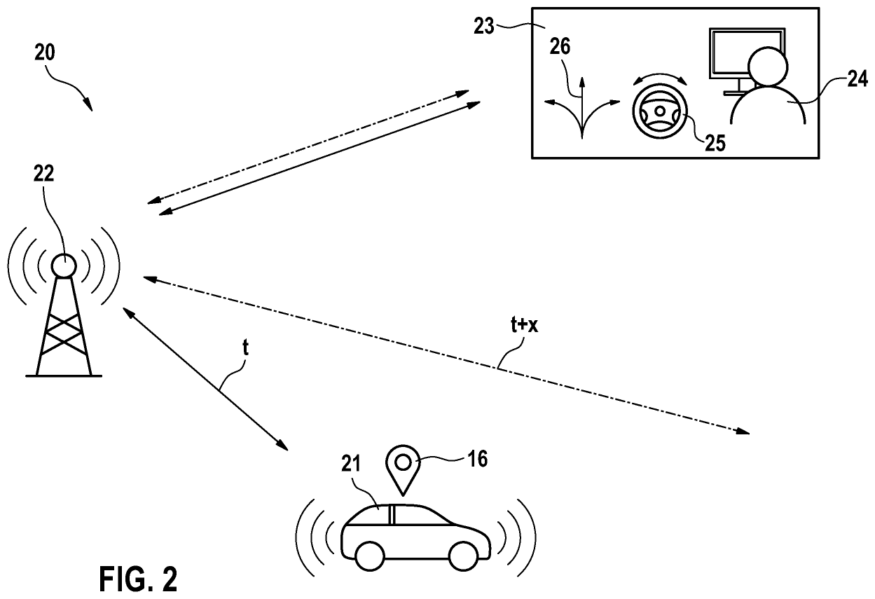

Resulting system 20 is now described in detail with reference to FIG. 2. It should be noted here that the teleoperated driving function significantly depends on the transfer quality. In order to ensure a safe operation of vehicle 21 under a wide variety of conditions, the function of the vehicle is adapted as described above. The presumably to be expected transfer quality is a prediction for the point in time t+x, x representing a time span limited merely by the maximum time horizon of the prediction.

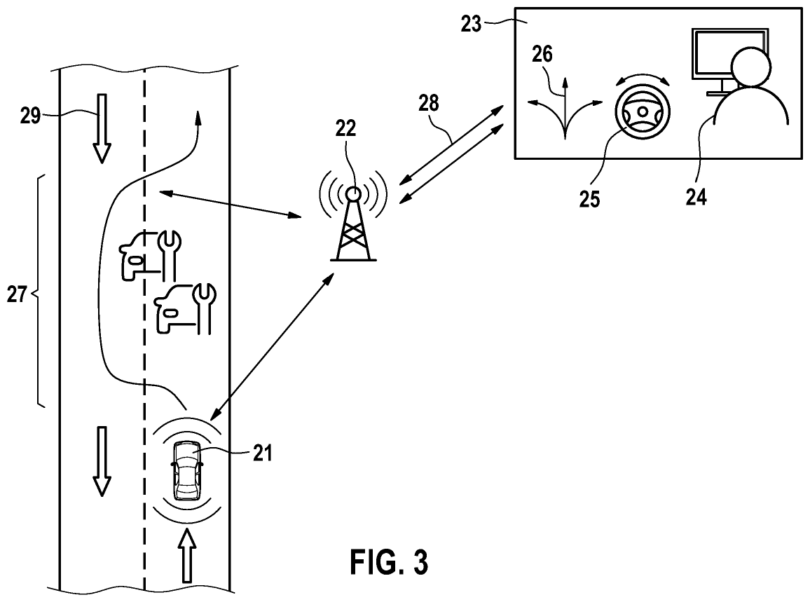

Finally, FIG. 3 highlights the functioning of system 20 according to FIG. 2: In the event vehicle 21 is remote controlled, the surroundings are identified 12 and classified, in particular, by measurements 14; pieces of knowledge 14, 15, 16 from maps 15, obtained from the infrastructure or from other road users, may also be incorporated into this classification. If during the ToD drive a hazard zone 27 such as oncoming lane 29 is to be negotiated, then it may be ascertained immediately beforehand by means of a prediction 28 whether the data rate and quality of mobile communications link 22 and the condition of vehicle 21 are sufficient for negotiating hazard zone 27. If this is not the case, functional range 17 or operating limits 18 provided to ToD operator 24, such as the maximum velocity of vehicle 21, may be restricted.

Alternatively to an actual reduction of these operating limits 18 or degradation of teleoperable functional range 17, operator 24 may—to the extent permitted by the responsibility concept underlying system 20—also merely be given a corresponding instruction and operator 24 may overrule system 20. Should it already emerge from QoS prediction 28 and surroundings identification 12 that it is not possible to negotiate a particular route, system 20 may suggest another route or provide to the operator 24 additional data in advance. Experience values obtained from other information sources may also be incorporated into this prediction 28.

This method 10 may, for example, be implemented in software or in hardware or in a mixed form of software and hardware, for example, in a control unit 21.

1-10. (canceled)

11. A method for teleoperated driving of a vehicle, the method comprising the following steps:
making a prediction with respect to a future quality of service of a mobile communications link of the vehicle to a vehicle control center;
acquiring pieces of knowledge relating to surroundings of the vehicle; and
carrying out adaptations relating to the teleoperated driving based on the pieces of knowledge and on the prediction.

12. The method as recited in claim 11, wherein the pieces of knowledge include at least one of the following:
measurements of the vehicle, or
pieces of map information, or
a location of the vehicle.

13. The method as recited in claim 12, wherein the adaptations relate to at least one of the following:
a functional range, or
operating limits, or
an area of operation of the vehicle established based on the pieces of map information.

14. The method as recited in claim 13, wherein the functional range includes at least one of the following:
an autonomous navigation to a driving destination selected by an operator, or
a remote controlled execution of driving maneuvers, or
driving along a predefined movement path.

15. The method as recited in claim 11, wherein:
a hazard zone situated ahead of the vehicle is identified based on the pieces of knowledge relating to the surroundings, and
the hazard zone is taken into account in the adaptations.

16. The method as recited in claim 11, wherein:
the adaptations to be carried out are gathered from a lookup table using a key derived from the pieces of knowledge, or
the adaptations to be carried out are calculated from the pieces of knowledge after the pieces of knowledge are acquired.

17. The method as recited in claim 11, wherein the prediction is made with respect to a predefined time window.

18. A non-transitory machine-readable memory medium on which is stored a computer program for teleoperated driving of a vehicle, the computer program, when executed by a computer, causing the computer to perform the following steps:
making a prediction with respect to a future quality of service of a mobile communications link of the vehicle to a vehicle control center;
acquiring pieces of knowledge relating to surroundings of the vehicle; and
carrying out adaptations relating to the teleoperated driving based on the pieces of knowledge and on the prediction.

19. A device for teleoperated driving of a vehicle, the device configured to:
make a prediction with respect to a future quality of service of a mobile communications link of the vehicle to a vehicle control center;
acquire pieces of knowledge relating to surroundings of the vehicle; and
carry out adaptations relating to the teleoperated driving based on the pieces of knowledge and on the prediction.
